(19) United States
(12) Patent Application Publication
(10) Pub. No.: US 2019/0391533 A1
(43) Pub. Date: Dec. 26, 2019

(54) TIMEPIECE DIAL WHOSE MATERIAL IS A LIGHT ALLOY

(71) Applicant: Rubattel & Weyermann S.A., La Chaux-de-Fonds (CH)

(72) Inventors: Philippe BARFUSS, Auvernier (CH); Frederic JEANRENAUD, La Chaux-de-Fonds (CH)

(73) Assignee: Rubattel & Weyermann S.A., La Chaux-de-Fonds (CH)

(21) Appl. No.: 16/465,305

(22) PCT Filed: Dec. 13, 2017
(86) PCT No.: PCT/EP2017/082534

§ 371 Date: May 30, 2019

(30) Foreign Application Priority Data
Dec. 21, 2016 (EP) 16205879.6

(51) Int. Cl. G04B 19/12; G04D 3/00; G04B 19/14

(52) U.S. Cl. CPC G04B 19/12; G04B 19/14; G04D 3/0002

(57) ABSTRACT

A method for manufacturing a one-piece timepiece dial assembly made of light alloy includes making, in a first assembled state, a dial including a flange whose material is a first light alloy, including opposite to the first side of a display area visible to a user, at least one foot for attachment to the dial. The flange includes at least one receiving area complementary to an end area of at least one foot which is a weldable foot that can be welded or brazed to the flange at the interface between the receiving area and the end area. The weldable foot is made of material that is the first light alloy or a second light alloy that can be welded or brazed to the first light alloy. The method further includes irreversibly assembling by welding or brazing at least one weldable foot to the flange.

### FIELD OF THE INVENTION

The invention concerns a timepiece dial whose material is a light alloy, including a flange whose material is a first light alloy, including, on a first side, at least one display area visible to a user, and, on a second side opposite to the first side, at least one foot for positioning and/or securing said dial in a timepiece movement.

The invention also concerns a one-piece dial assembly, whose material is a light alloy, including such a dial.

The invention also concerns a method for manufacturing a one-piece timepiece dial assembly whose material is a light alloy.

The invention concerns the field of display components for horology or for scientific instruments or measuring devices.

### BACKGROUND OF THE INVENTION

Timepiece dials or scientific instruments include feet for attachment and/or positioning on a plate or inside a movement.

Often, these feet are useful for the dial manufacturing method, for attaching supports or for carrying out depositions in electroplating baths, by performing the dual function of retaining element and current guide.

Generally, these feet are made of copper, coated with a thin gold film to prevent oxidation and to improve electrical contact. The dials are generally made of copper alloy, brass, nickel silver or similar, and therefore behaviour in different steps of the method is the same on the dial and the feet comprised therein.

The resistance welding process makes it possible to join the feet and the dial by subjecting them to an energy pulse in the direction of the foot, the energy locally melting the metal at the interface between the dial and the foot, at one end of the foot, referred to as the pivot, which has a defined diameter, often smaller than the diameter of the foot, over a defined height, and which forms a fusible element which provides the connection to the dial.

However, such copper alloy feet are not suitable for producing dials made from certain light alloys, particularly aluminium alloys. Indeed, copper alloy feet dissolve during electrochemical conversion processes, such as anodization, anodic oxidation or similar, in baths or electrolytes including sulphuric or nitro sulphuric acid.

It is thus desirable to make the feet from a material having the same behaviour as the material of the dial. Producing the feet in one piece with the dial flange is expensive in a milling machining process, or difficult to achieve by stamping.

For this reason, it is not unusual to see dials made of light alloy with a flange subjected to all the galvanic treatments, on which copper alloy feet are then placed. Or dials without feet, fixed to the movement by loops.

US Patent Application No. 3803832A in the name of SHIMIZU discloses a watch dial including a body formed of a flat plate of aluminium and rivets forming pin members made of aluminium material and forming attachments to a movement. The head of each pin is shaped to fit inside a recess formed on the rear surface of the body and is integrally secured to the recess by means of ultrasonic welding. One manufacturing method implements an ultrasonic welding machine to integrally join the head and recess.

CH Patent Application No 332878A in the name of RIHS discloses a method for manufacturing a dial from a sheet by stamping, especially to form numerals in relief, and by cutting, after which the numerals in relief are ground, and the plate is chemically polished before anodic oxidation is applied thereto with at least one dye product.

### SUMMARY OF THE INVENTION

The invention proposes to place feet made of light alloy, particularly aluminium or titanium alloy, on a bare dial flange made of light alloy, particularly aluminium or titanium alloy, to transform this bare dial into a dial assembly including feet rigidly joined to the flange and having the same chemical behaviour as the flange.

To this end, the invention concerns a timepiece dial according to claim 1.

The invention also concerns a one-piece dial assembly according to claim 6.

The invention also concerns a method for manufacturing such a one-piece timepiece dial assembly according to claim 10.

### BRIEF DESCRIPTION OF THE DRAWINGS

Other features and advantages of the invention will appear upon reading the following detailed description, with reference to the annexed drawings, in which:

FIG. 1 represents a schematic sectional view of a bare dial, assembled but not welded or brazed, comprising a flange with, opposite to an upper display surface, a lower surface on which are shown feet intended to be welded or brazed on the flange.

FIG. 2 represents a schematic sectional view of a detail of such a bare dial wherein the junction between the foot and the flange is a flat surface.

FIG. 3 represents a schematic sectional view of a detail of such a bare dial wherein the junction between the foot and the flange is a cylindrical fit with the foot penetrating a bore in the flange.

FIG. 4 represents a schematic sectional view of a detail of such a bare dial wherein the junction between the foot and the flange is a contact point between a slight relief comprised in the flange and a housing comprised in the foot.

FIG. 5 represents a schematic sectional view of a detail of such a bare dial wherein the junction between the foot and the flange is a screw connection between an internal thread opening comprised in the flange and an external thread of the foot.

FIG. 6 represents a schematic sectional view of a detail of such a bare dial wherein the junction between the foot and the flange is on a circular groove comprised in the flange, which carries a U-shaped notch comprised in the foot.

FIG. 7 represents a schematic sectional view of a detail of such a bare dial wherein the junction between the foot and the flange is in a circular slot comprised in the flange which receives a straight stud with parallel sides comprised in the foot.

FIG. 8 represents a schematic view of a dial assembly irreversibly assembled by welding or brazing.

FIG. 9 represents a schematic view of a watch including such a dial assembly

FIG. 10 represents a schematic view of a measuring instrument or scientific device including such a dial assembly.

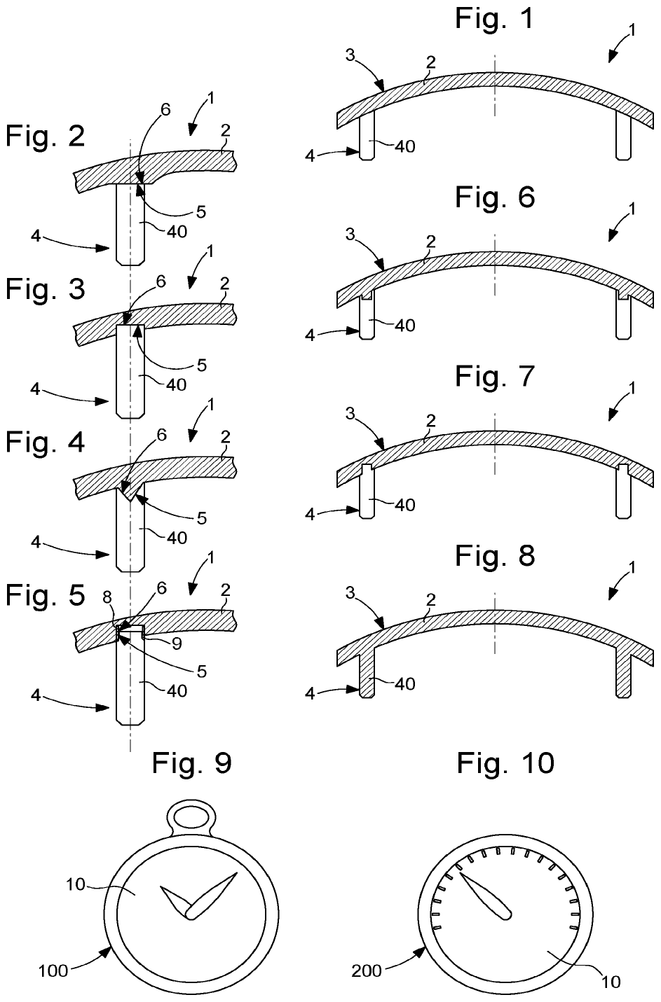

### DETAILED DESCRIPTION OF PREFERRED EMBODIMENTS

The invention concerns a timepiece dial 1 whose material is a light alloy, including a flange 2 whose material is a first light alloy.

More particularly, this dial 1 is flat, or substantially flat, or has a radius of curvature of more than 30 mm.

This flange 2 includes, on a first side, at least one display area 3 visible to a user, and on a second side opposite to the first front side and called the back side, at least one foot 4 for positioning and/or securing dial 1 in a timepiece movement 100.

This dial 1 is a dial whose components, especially feet 4, can be disassembled.

According to the invention, flange 2 includes at least one receiving area 5 complementary to an end area 6 of at least one foot 4, which is a weldable foot 40, which is arranged to be welded or brazed to flange 2 at the interface between receiving area 5 and end area 6. The material forming such a weldable foot 40 is the first light alloy, or a second light alloy which can be welded or brazed to the first light alloy.

At least one such receiving area 5 envelops a respective end area 6 relative to the assembly of the same weldable foot 40, or at least one end area 6 envelops a respective receiving area 5 relative to the assembly of the same weldable foot 40, or at least one pair formed of an end area 6 and a complementary receiving area 5 includes, in a first, non-welded and non-brazed assembled state, an internal thread cooperating with an external thread.

In an advantageous variant that facilitates preparation and retention during subsequent operations, at least one receiving area 5 includes a profile arranged to abuttingly engage in a complementary manner with a complementary profile comprised in a respective end area 6 relative to the assembly of the same weldable foot 40.

In a variant, at least one receiving area 5 envelops a respective end area 6 relative to the assembly of the same weldable foot 40.

In another variant, at least one end area 6 envelops a respective receiving area 5 relative to the assembly of the same weldable foot 40.

In another variant, at least one receiving area 5 is arranged to rest flat on a respective end area 6 relative to the assembly of the same weldable foot 40.

In yet another variant, at least one pair formed of an end area 6 and a complementary receiving area 5 includes, in a first, non-welded, non-brazed assembled state, an internal thread cooperating with an external thread.

In yet another variant, at least one receiving area 5 is part of a circular slot or rib, in particular created during a turning machining operation on flange 2, and end area 6, which is complementary thereto, is part of a complementary circular rib or slot.

More particularly, the first light alloy and the second light alloy are chosen from among alloys of aluminium, titanium or magnesium.

In another variant the first light alloy and/or the second light alloy is replaced by the assembly formed of a pure metal coated with its oxide layer produced on contact with the atmosphere, such as Al₂O₃ for aluminium, or TiO₂ for titanium.

In a variant the first light alloy and the second light alloy are two aluminium alloys. These alloys are preferably chosen from among the aluminium alloys that are the easiest to weld. More particularly and not exclusively, they are chosen from aluminium alloys without precipitation hardening, of the 1000 series (without alloying elements) and more particularly the 1050-O series in the annealed condition, the 3000 series (with the addition of manganese) and more particularly the 3003-O series in the annealed condition, the 5000 series (with the addition of magnesium) which welds well and is suitable for anodization, and more particularly the 5086-O series in the annealed condition, or the work-hardened and stabilised 5083 H111 series.

In another variant, the first light alloy is an aluminium alloy and the second light alloy is a titanium alloy, such as TiO₂, TiAl₆ V₄ called TA6V, or suchlike. Or the second light alloy is an aluminium alloy and the first light alloy is a titanium alloy, such as TiO₂, TiAl₆ V₄ called TA6V, or suchlike.

In yet another variant, the first light alloy is an aluminium alloy and the second light alloy is a magnesium alloy which welds well with aluminium, such as MgAl₆Zn₃ called G-A6Z3, or MgAl₉Zn called G-A9Z, or MgZn₅Th₂Zr, or MgZr. The opposite configuration is naturally possible.

The invention also concerns a one-piece dial assembly 10, whose material is a light alloy, comprising a bare dial 1, and which results from the transformation of this dial 1 by at least one welding or brazing operation which irreversibly joins those components that have been welded or brazed together, in particular flange 2 and all or part of feet 4. The welded or brazed connection area no longer includes any trace of the original geometry of end areas 6 and complementary receiving areas 5 affected by the welding or brazing operation.

Thus, according to the invention, in at least one pair formed of one end area 6 and a complementary receiving area 5, end area 6 and receiving area 5 are permanently joined at a welded or brazed connection between flange 2 and the weldable foot 40 concerned.

To this end, there are technologies compatible with the micro-welding of aluminium and/or titanium, in a very targeted manner, to avoid any deformation of visible display area 3, using laser or plasma technology, with heated areas of very small diameter, on the order of 100 microns, and reduced heating. These technologies make it possible to weld or braze such a weldable foot 40 made of light alloy, particularly titanium or aluminium alloy, welded by butt or spot welding, and especially by laser or plasma or ultrasonic welding.

More particularly, in each pair formed of an end area 6 and a complementary receiving area 5, end area 6 and receiving area 5 are permanently joined at a welded or brazed connection between flange 2 and the weldable foot 40 concerned.

In an advantageous variant, one-piece dial assembly 10 includes an anodized surface layer, or a surface layer of chromic or sulphuric anodic oxidation, the corresponding surface treatment being performed after the welding or brazing operations.

The invention also concerns a watch 1000 including at least one such dial assembly 10.

The invention also concerns a scientific instrument including one such dial assembly 10.

The invention also concerns a measuring device including one such dial assembly 10.

The invention also concerns a method for manufacturing a one-piece timepiece dial assembly whose material is a light alloy. According to the invention, the following steps are performed in following order:

making, in a first, non-welded and non-brazed assembled state, a timepiece dial 1 whose material is a light alloy, including a flange 2 whose material is a first light alloy, including, on a first side, at least one display area 3 visible to a user, and on a second side opposite to the first front side and called the back side, at least one foot 4 for positioning and/or securing dial 1 in a timepiece movement 100. This flange 2 includes at least one receiving area 5 complementary to an end area 6 of at least one foot 4, which is a weldable foot 40 arranged to be welded or brazed to flange 2 at the interface between receiving area 5 and end area 6. The material forming such a weldable foot 40 is the first light alloy, or a second light alloy that can be welded or brazed to the first light alloy;

making this at least one receiving area 5 complementary to end area 6 such that one envelops the other or vice versa, and/or providing them with an internal thread cooperating with an external thread;

in this first non-welded and non-brazed assembled state, positioning at least one receiving area 5 so that it envelops a respective end area 6 relative to the assembly of the same weldable foot 40, or vice versa, and/or screwing one to the other;

irreversibly assembling by welding or brazing at least one weldable foot 40 to flange 2 to form this one-piece dial assembly 10.

More particularly, dial 1 is made flat, or substantially flat, or with a radius of curvature of more than 30 mm.

More particularly, each weldable foot 40 is irreversibly assembled by welding or brazing to flange 2.

More particularly, dial 1 is made before welding or brazing with at least one receiving area 5 which envelops, in the first non-welded and non-brazed assembled state, a respective end area 6 relative to the assembly of the same weldable foot 40.

More particularly, dial 1 is made before welding or brazing with at least one end area 6 which envelops, in the first non-welded and non-brazed assembled state, a respective receiving area 5 relative to the assembly of the same weldable foot 40. More particularly, dial 1 is made before welding or brazing with at least one pair formed of an end area 6 and a complementary receiving area 5, which includes, in a first, non-welded and non-brazed assembled state, an internal thread cooperating with an external thread.

More particularly, after irreversible assembly by welding or brazing, an operation of anodization, or chromic or sulphuric anodic oxidation of the surface layer of dial assembly 10 is performed.

In a variant, the first light alloy and the second light alloy are chosen from among alloys of aluminium, of titanium or of magnesium.

In a variant, the first light alloy and the second light alloy are chosen to be two aluminium alloys.

In a variant, the first light alloy and the second light alloy are chosen to be two titanium alloys.

In a variant, the first light alloy and the second light alloy are chosen to be two magnesium alloys.

In a variant, the first light alloy is chosen to be an aluminium alloy and the second light alloy is chosen to be a titanium alloy or vice versa.

The particular choice of a first light alloy and a second light alloy which are both aluminium alloys is advantageous for application of an anodization process.

The alternative of feet made of titanium or titanium alloy gives the same possibilities with the advantage of great dimensional stability regardless of the number of treatments applied. This alternative is advantageous for application of various chemical conversion treatments on the same dial.

The fact of welding or brazing the feet at the start of the cycle avoids the risk of scrap at the end of production when the product has reached its maximum value.

1-21. (canceled)

22: A timepiece dial whose material is a light alloy, including a flange whose material is a first light alloy, including, on a first side, at least one display area visible to a user, and, on a second side, at least one foot for positioning and/or securing said dial in a timepiece movement, said flange including at least one receiving area complementary to an end area of the at least one foot, which is a weldable foot arranged to be welded or brazed to said flange at the interface between said receiving area and said end area, and wherein the material of said weldable foot is said first light alloy or a second light alloy that can be welded or brazed to said first light alloy, wherein at least one said receiving area envelops a said respective end area relative to the assembly of the weldable foot, or wherein at least one said end area envelops said respective receiving area relative to the assembly of the weldable foot, or wherein at least one pair formed of said end area and said complementary receiving area includes, in a first, non-welded and non-brazed assembled state, an internal thread cooperating with an external thread, wherein said first light alloy is an aluminum alloy, and wherein said second light alloy is a titanium alloy, or vice versa.

23: A timepiece dial whose material is a light alloy, including a flange whose material is a first light alloy, including, on a first side, at least one display area visible to a user, and on a second side, at least one foot for positioning and/or securing said dial in a timepiece movement, said flange including at least one receiving area complementary to an end area of the at least one foot which is a weldable foot arranged to be welded or brazed to said flange at the interface between said receiving area and said end area, and wherein the material of said weldable foot is said first light alloy or a second light alloy that can be welded or brazed to said first light alloy, wherein at least one pair formed of said end area and said complementary receiving area includes, in a first, non-welded and non-brazed assembled state, an internal thread cooperating with an external thread.

24: The dial according to claim 23, wherein said first light alloy and said second light alloy are chosen from among alloys of aluminum, of titanium, or of magnesium.

25: The dial according to claim 24, wherein said first light alloy and said second light alloy are two aluminum alloys.

26: The dial according to claim 24, wherein said first light alloy is an aluminum alloy, and wherein said second light alloy is a titanium alloy, or vice versa.

27: A one-piece dial assembly whose material is a light alloy, comprising the dial according to claim 22, wherein, in at least one pair formed of said end area and said complementary receiving area, said end area and said receiving area are permanently joined at a welded or brazed connection between said flange and said weldable foot concerned.

28: The one-piece dial assembly according to claim 27, wherein, in each pair formed of said end area and said complementary receiving area, said end area and said receiving area are permanently joined at a welded or brazed connection between said flange and said weldable foot concerned.

29: The one-piece dial assembly according to claim 27, wherein said dial assembly includes an anodized surface layer, or a surface layer of chromic or sulphuric anodic oxidation.

30: A one-piece dial assembly whose material is a light alloy, comprising the dial according to claim 23, wherein, in at least one pair formed of said end area and said complementary receiving area, said end area and said receiving area are permanently joined at a welded or brazed connection between said flange and said weldable foot concerned.

31: The one-piece dial assembly according to claim 30, wherein, in each pair formed of said end area and said complementary receiving area, said end area and said receiving area are permanently joined at a welded or brazed connection between said flange and said weldable foot concerned.

32: The one-piece dial assembly according to claim 31, wherein said dial assembly includes an anodized surface layer, or a surface layer of chromic or sulphuric anodic oxidation.

33: A watch including the dial assembly according to claim 27.

34: A method for manufacturing a one-piece timepiece dial assembly whose material is a light alloy, wherein the following steps are performed in the following order:
making, in a first, non-welded and non-brazed assembled state, a timepiece dial whose material is a light alloy, including a flange whose material is a first light alloy, including, on a first side, at least one display area visible to a user, and on a second side, at least one foot for positioning and/or securing said dial in a timepiece movement, said flange including at least one receiving area complementary to an end area of at least one said foot which is a weldable foot arranged to be welded or brazed to said flange at the interface between said receiving area and said end area, and wherein the material of said weldable foot is said first light alloy or a second light alloy that can be welded or brazed to said first light alloy;
choosing said first light alloy to be an aluminum alloy and said second light alloy to be a titanium alloy or vice versa;
making said at least one receiving area complementary to the end area such that one envelops the other or vice versa, and/or making said areas to include an internal thread cooperating with an external thread;
in said first non-welded and non-brazed assembled state, positioning at least one said receiving area so that it envelops a said respective end area relative to the assembly of said weldable foot, or vice versa, and/or screwing one to the other;
irreversibly assembling by welding or brazing at least one said weldable foot to said flange to form said one-piece dial assembly.

35: A method for manufacturing a one-piece timepiece dial assembly whose material is a light alloy, wherein the following steps are performed in the following order:
making, in a first, non-welded and non-brazed assembled state, a timepiece dial whose material is a light alloy, including a flange whose material is a first light alloy, including, on a first side, at least one display area visible to a user, and on a second side, at least one foot for positioning and/or securing said dial in a timepiece movement, said flange including at least one receiving area complementary to an end area of at least one said foot which is a weldable foot arranged to be welded or brazed to said flange at the interface between said receiving area and said end area, and wherein the material of said weldable foot is said first light alloy or a second light alloy that can be welded or brazed to said first light alloy;
making said dial before welding or brazing with at least one pair formed of said end area and said complementary receiving area, which includes, in said first non-welded and non-brazed assembled state, an internal thread cooperating with an external thread;
in said first non-welded and non-brazed assembled state, positioning at least one said receiving area so that it envelops said respective end area relative to the assembly of said weldable foot, or vice versa, and/or screwing one to the other;
irreversibly assembling by welding or brazing at least one said weldable foot to said flange to form said one-piece dial assembly.

36: The method for manufacturing a dial assembly according to claim 34, wherein each said weldable foot is irreversibly assembled by welding or brazing to said flange.

37: The method for manufacturing a dial assembly according to claim 34, wherein said dial is made before welding or brazing with at least one said receiving area which envelops, in said first non-welded and non-brazed assembled state, said respective end area relative to the assembly of said weldable foot.

38: The method for manufacturing a dial assembly according to claim 34, wherein said dial is made before welding or brazing with at least one said end area which envelops, in said first non-welded and non-brazed assembled state, said respective end area relative to the assembly of said weldable foot.

39: The method for manufacturing a dial assembly according to claim 34, wherein said dial is made before welding or brazing with at least one pair formed of said end area and said complementary receiving area, which includes, in a first, non-welded and non-brazed assembled state, an internal thread cooperating with an external thread.

40: The method for manufacturing a dial assembly according to claim 34, wherein, after irreversible assembly by welding or brazing, an operation of anodization, or chromic or sulphuric anodic oxidation of the surface layer of said dial assembly is performed.

41: The method for manufacturing a dial assembly according to claim 35, wherein said first light alloy and said second light alloy are chosen from among alloys of aluminum, of titanium, or of magnesium.

42: The method for manufacturing a dial assembly according to claim 41, wherein said first light alloy and said second light alloy are chosen to be two aluminum alloys.

43: The method for manufacturing a dial assembly according to claim 41, wherein said first light alloy and said second light alloy are chosen to be two titanium alloys.

44: The method for manufacturing a dial assembly according to claim 41, wherein said first light alloy and said second light alloy are chosen to be two magnesium alloys.

45: The method for manufacturing a dial assembly according to claim 41, wherein said first light alloy is chosen to be an aluminum alloy and said second light alloy is chosen to be a titanium alloy, or vice versa.
